(19) United States
(12) Patent Application Publication
(10) Pub. No.: US 2010/0098204 A1
(43) Pub. Date: Apr. 22, 2010

(54) Systems and Methods for Regulating Clock Precision in Distributed Devices

(75) Inventors: Ovidiu Ratiu, Marietta, GA (US); Ion Ticus, Bucuresti (RO)

Correspondence Address: JOHN S. PRATT, ESQ;KILPATRICK STOCKTON, LLP, 1100 PEACHTREE STREET, SUITE 2800, ATLANTA, GA, 30309, US

(73) Assignee: Nivis, LLC, Atlanta, GA (US)

(21) Appl. No.: 12/533,381

(22) Filed: Jul. 31, 2009

Related U.S. Application Data
(60) Provisional application No. 61/085,727, filed on Aug. 1, 2008.

(51) Int. Cl. H04L 7/00

(52) U.S. Cl. 375/371

(57) ABSTRACT

Systems and methods for regulating clock precision are disclosed. One embodiment is a method including receiving a clock signal from an oscillator, maintaining a signal count based on the clock signal; receiving a message comprising timing information from a remote device, calculating a drift value based at least in part on the timing information, and determining whether the drift is greater than a targeted clock accuracy. While the drift value is greater than the targeted clock accuracy, adjusting the signal count by the targeted clock accuracy, reducing the drift value by the targeted clock accuracy, and waiting a partial correction interval. If the drift value is less than the targeted clock accuracy, adjusting the signal count by the drift value. Then determining a receive time for a network message based at least in time on the signal count, and activating a wireless receiver based on the receive time to receive a message.

### CROSS-REFERENCE TO RELATED APPLICATIONS

This application claims priority to U.S. Provisional Patent Application No. 61/085,727, filed Aug. 1, 2008 entitled “Systems and Methods for Regulating Clock Precision in Distributed Devices,” the entirety of which is incorporated herein by reference.

### FIELD OF THE INVENTION

The present invention relates generally to clock precision, and more specifically to regulating clock precision in distributed devices.

### BACKGROUND

In a network of distributed devices, it may be desirable to activate networking functionality in a device when it needs to transmit data, or when it is expecting to receive a transmission from another device. For example, in a battery-powered device, the ability to disable transmit/receive circuitry may increase the device's battery life. For a device to activate receive circuitry in time to receive an expected message, the device should be synchronized with the transmitting device so that the receiving device is ready to receive when the transmitting device sends a message. However, the devices in the network may be at least partially dependent on internal timing mechanisms, such as clocks, to maintain a reference time base to remain synchronized with other devices in the network.

For example, in distributed devices, a time base is typically provided by a processor, such as through the use of a crystal oscillator. A time base can be maintained by using a counter that counts the number of oscillations of the crystal. The counter may then be configured to reset after a desired time period, such as 100 microseconds, by calculating the number oscillations that will occur in the desired minimum time period. However, over time, different devices may measure the same time period differently due to differences between their crystal oscillators. Such differences may eventually cause the devices to become desynchronized and unable to communicate with each other.

### SUMMARY

Embodiments of the present invention provide systems and methods for regulating clock precision in distributed devices. For example, in one embodiment of a method for regulating clock precision in distributed devices, a method comprises the steps of receiving a clock signal from an oscillator, maintaining a signal count based on the clock signal; receiving a message comprising timing information from a remote device, calculating a drift value based at least in part on the timing information, and determining whether the drift is greater than a targeted clock accuracy. While the drift value is greater than the targeted clock accuracy, adjusting the signal count by the targeted clock accuracy, reducing the drift value by the targeted clock accuracy, and waiting a partial correction interval. If the drift value is less than the targeted clock accuracy, adjusting the signal count by the drift value. The method further comprises determining a receive time for a network message based at least in time on the signal count, and activating a wireless receiver based on the receive time to receive a message. In another embodiment, a computer-readable medium comprises program code for carrying out such a method.

These illustrative embodiments are mentioned not to limit or define the invention, but to provide examples to aid understanding thereof. Illustrative embodiments are discussed in the Detailed Description, and further description of the invention is provided therein. Advantages offered by various embodiments of this invention may be further understood by examining this specification.

### BRIEF DESCRIPTION OF THE DRAWINGS

These and other features, aspects, and advantages of the present invention are better understood when the following Detailed Description is read with reference to the accompanying drawings, wherein:

FIG. 1 shows a system for regulating clock precision in distributed devices according to one embodiment of the present invention;

FIG. 2 shows a system for regulating clock precision in distributed devices according to one embodiment of the present invention;

FIG. 3 shows a method for regulating clock precision in distributed devices according to one embodiment of the present invention; and

FIG. 4 shows a method for regulating clock precision in distributed devices according to one embodiment of the present invention.

### DETAILED DESCRIPTION

Embodiments of the present invention provide systems and methods for regulating clock precision in distributed devices. Embodiments disclosed herein are meant to be illustrative examples and not to limit the scope of the invention.

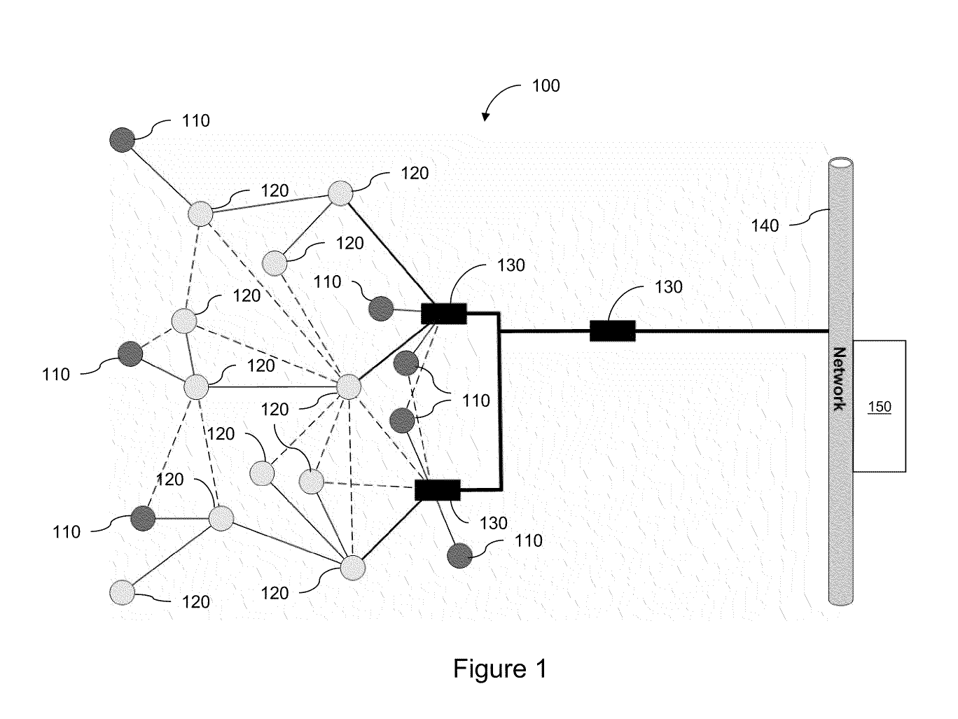

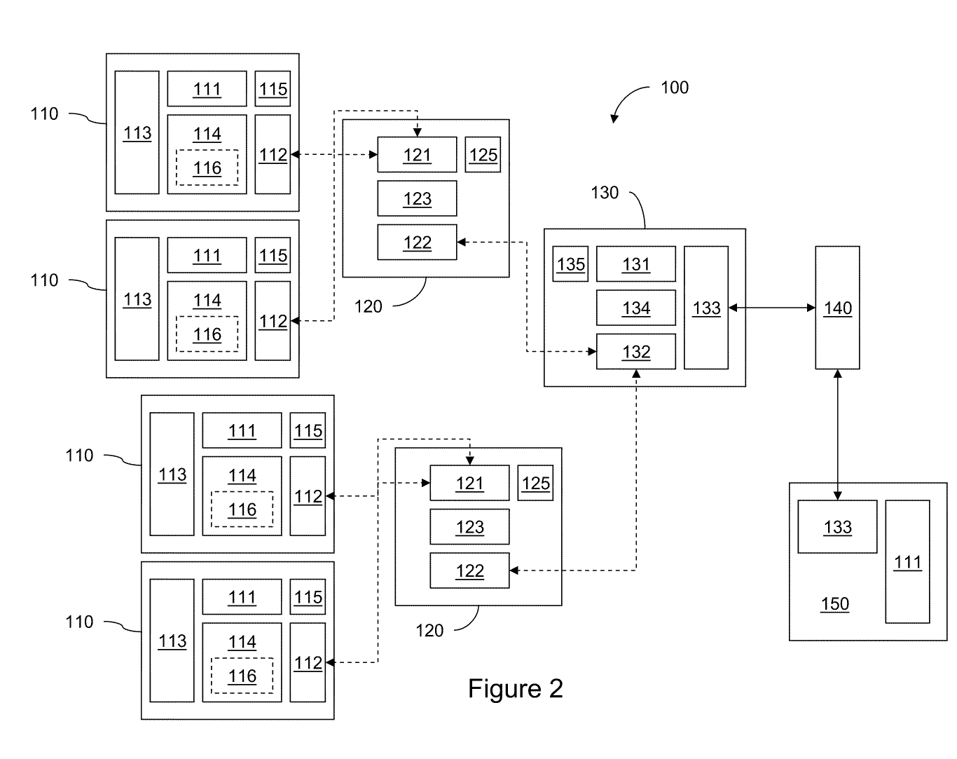

Referring now to FIG. 1, FIG. 1 shows a system 100 for regulating clock precision in distributed devices according to one embodiment of the present invention. The system 100 shown in FIG. 1 comprises a plurality of remote devices 110, also referred to as non-routing devices, a plurality of routing devices 120, a plurality of backbone routers 130, a network 140, and a control system 150. As may be seen in FIG. 1, each of the non-routing devices 110 is in communication with at least one routing device 120, and each of the routing devices 120 is in communication with at least one backbone router 130. The backbone router 130 then provides a communication path to the network 140. The control system 150 is in communication with the network 140 as well as each of the backbone routers 130, routing devices 120, and non-routing devices 110. A more detailed view of the components of the system 100 shown in FIG. 1 can be seen in FIG. 2.

FIG. 2 shows a system 100 for regulating clock precision in distributed devices according to one embodiment of the present invention. As can be seen in FIG. 2, the non-routing devices 110 each comprise a processor 111, a crystal oscillator 115, a memory 114 comprising application software 116, a sensor 113, and a wireless communication device 112. The routing devices 120 each comprise a processor 121, a crystal oscillator 125, a memory 123, and a wireless communication device 122. Additionally, in some embodiments, a routing device 120 may also comprise a sensor 113. The backbone router 130 comprises a processor 131, a crystal oscillator 135, a memory 134, a wireless communication device 132, and a wired communication device 133.

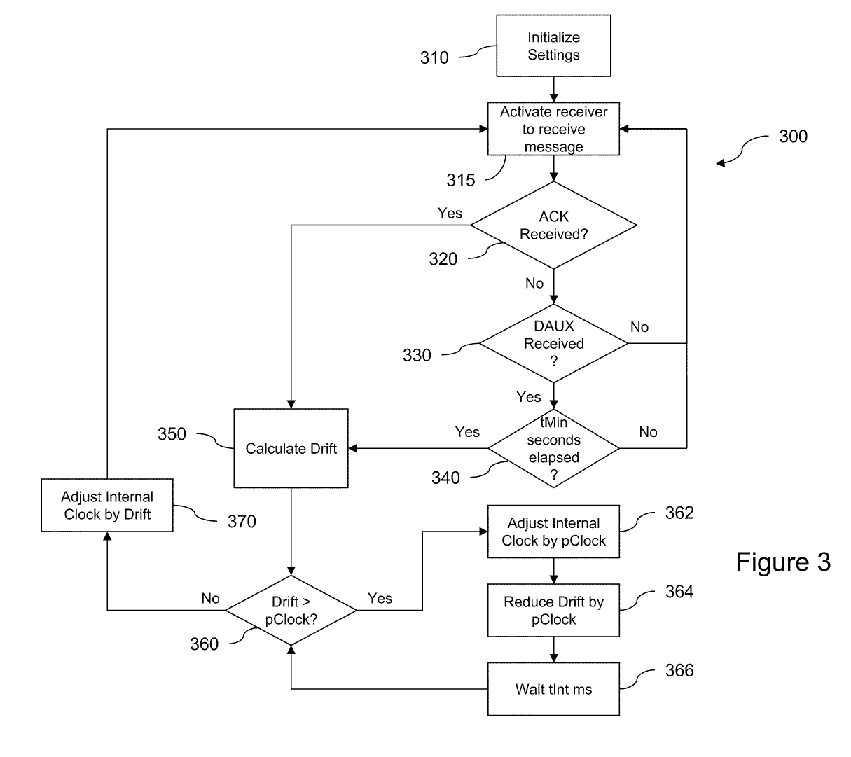

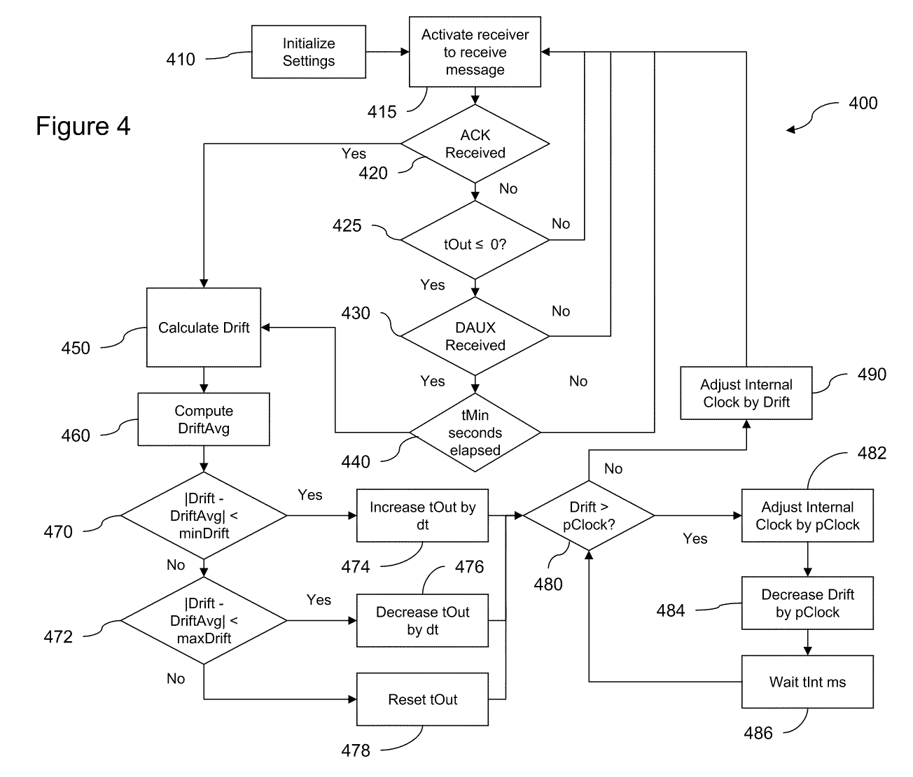

In the embodiment shown in FIG. 2, the application software 116 is configured to maintain a time base for the device and to execute a method for regulating clock precision in a distributed environment. For example, in one embodiment of the present invention, the application software 116 is configured to maintain a time base by counting oscillations of the crystal oscillator. In addition, the application software 116 is configured to regulate the time base according to the method shown in FIG. 3 and the corresponding description below. In another embodiment, the application software 116 is configured to maintain a time base and to regulate the time base according to the method shown in FIG. 4 and the corresponding description below.

In the non-routing devices 110 shown in FIGS. 1 and 2, the processor 111 is in communication with a memory 114 that comprises a computer-readable medium. The memory 114 stores application software and other configuration information used by the processor 111 to perform various tasks to be executed by the non-routing device 110. For example, in one embodiment of the present invention, the processor 111 is configured to execute software 116 stored in memory 114, to read data from sensor 113, to store the sensor data in the memory 114 to regulate clock precision in a distributed environment, and to transmit the sensor data to the control system 150.

The processor 111 in each non-routing device is in communication with a crystal oscillator 115. The crystal oscillator 115 is configured to oscillate approximately at a fixed frequency, though this frequency may vary slightly over time. Each non-routing device 110 is configured to receive signals from the crystal oscillator 115. Each non-routing device 110 also comprises application software stored in memory 114 to maintain a time base based on signals received from the crystal oscillator 115 and to regulate clock precision. For example, in one embodiment, a non-routing device 110 may maintain a time base by using a software application 116 to count the number of signals received from the crystal oscillator and store the value in memory 114. The signal count may later be multiplied by a value corresponding to the period of one oscillation. In another embodiment, the processor 111 may execute software 116 to maintain two counts—one that is incremented based on signals received from the crystal, and a second count that increments after some number of oscillations has occurred. For example, the second counter may be incremented after 1000 oscillations, which may correspond to a time period of approximately 100 microseconds. Thus, by counting signals received from the crystal oscillator 115, software 116 executed by the processor 111 may be able to track the passage of time and the schedule events to occur at particular times.

In addition, each of the routing device 120 and backbone devices 130 comprises a crystal oscillator 125, 135 as well. The processors 121, 131 in each routing device 120 and each backbone device 130 are configured to receive signals from their respective crystal oscillators 125, 135 as well to maintain a time base. However, the quality of the crystal oscillators 135 in the backbone devices may be of higher quality and less prone to variance in frequency over time than the crystal oscillators 115, 125 in the non-routing and routing devices 110, 120.

In the embodiment shown in FIGS. 1 and 2, the wireless communication devices 112 are in communication with the processor 111 and comprise wireless devices capable of communicating using the IEEE 802.15.4 protocol. However, other suitable wireless communication devices 112 maybe used, such as 802.11 wireless Ethernet transceiver, or cellular radios.

Non-routing devices 110 comprise sensors 113 capable of collecting data. For example, the non-routing devices 110 may be incorporated into a pipe running through a plant or factory. Non-routing devices 110 in such an embodiment may comprise pressure sensors capable of detecting internal gas or fluid pressures within the pipe. Non-routing devices 110 in other embodiments may comprise other types of sensors, or a plurality of sensors.

In the embodiment shown in FIGS. 1 and 2, routing devices 120 comprise a processor 121, a crystal oscillator 125, a memory 123, and a wireless communication device 122. Similar to each non-routing device 110, each routing device 120 also comprises application software in memory 123 to maintain a time base based on signals received from the routing device's crystal oscillator 125 in a manner similar to those described for the non-routing devices 110. In addition, some of the routing devices 120b further comprise a sensor 113. In the embodiment shown, a routing device 120 may comprise a non-routing device 110 that has been configured to act as a routing device. For example, the routing device 120b comprises a non-routing device 110, but a software configuration parameter stored in memory 123 of the non-routing device has been set to enable routing functionality. Similarly, in the embodiment shown, the non-routing devices 110 each may be capable of acting as routing devices; however, the routing capabilities have been disabled by a configuration setting.

In the embodiment shown in FIGS. 1 and 2, as a part of software executed by the processors 111, each non-routing device 110 and routing device 120 maintains a time base that is used to ensure that events or actions occur at the proper time. For example, a radio message may be expected at time, t=0, and then every 250 ms thereafter. However, the crystal oscillators 115, 125 of each device 110, 120 may tend to drift with respect to the crystal oscillators 115, 125, 135 of other devices 110, 120, 130. For example, if the crystal oscillator 115 of a non-routing device 110 drifts relative to the crystal oscillator 125 of a routing device 120, at some time after t=0, the time base tracked by the non-routing device 110 will have drifted too much from the time base tracked by the routing device 120 to allow the two devices to communicate. For example, the non-routing device 110 may turn on its radio to receive an expected message from the routing device after the routing device has already transmitted the message. Thus, one advantage provided by some embodiments of the present invention may be that time bases within a plurality of distributed, discrete devices may be regulated and approximately synchronized. Another advantage may be that inexpensive devices with less accurate clock crystals may be used and regulated to remain synchronized with time bases in other devices.

Referring now to FIG. 3, FIG. 3 shows a method for regulating clock precision in distributed devices according to one embodiment of the present invention. The method shown in FIG. 3 is described with respect to the system shown in FIGS. 1 and 2.

The embodiment shown in FIG. 3 provides regulation of clock precision in distributed devices within a communication network. The method 300 may be executed by a processor 111, 121 on each non-routing device 110 and routing device 120 within the system 100. At a high level, in one embodiment, the method 300 regulates clock precision by using timing information received from at least one of two different types of messages used within the system 100: message acknowledgements (ACK) and DAUX messages. Each of these message types are more fully described in the ISA 100 network specification. However, other types of timing messages may be used, including user-defined timing messages. These messages typically may be sent by any device in the system, but only timing messages from devices that have been configured to be ‘clock sources’ will be used for synchronization purposes. Any device may be designated as a clock source, however, typically, only devices running on line power, rather than battery power, will be designated as clock sources. For example, backbone routers 130 may be designated as clock sources in one embodiment as they are likely to be line-powered.

As described above, two different types of messages may provide synchronization information, however, they do not provide information of equal quality. ACK messages, as defined in the ISA 100 specification, include time synchronization information with 2⁻²⁰ resolution and generally provide more precise timing information than the DAUX messages, which only provide timing information with 2⁻¹⁵ resolution. However, ACK messages may occur infrequently or at irregular intervals, and therefore timing information from the DAUX message may be used instead. Further, in one embodiment, if an ACK message has been recently received, the next DAUX message may be ignored.

In one embodiment, the timing information received from the ACK or DAUX message is used to calculate a ‘Drift’ value based on the time base (such as a processor register that counts oscillations of the crystal). The time base maintained by the device is then adjusted by the processor to compensate for the drift. However, the method described below does not necessarily immediately correct for the entire drift in a single iteration. Rather, in one embodiment, the time base is adjusted by, at most, a maximum correction value. Additional adjustments are likewise made incrementally until the time base is synchronized based on the received timing information. The method shown in FIG. 3 is configured to be loaded into memory as a part of a software application and executed by a processor. The following is a more detailed description of the method 300 shown in FIG. 3.

The method 300 begins in step 310. In the embodiment shown, the processor in a device, such as a non-routing device 110 or a routing device 120, executes application software that initializes several variables for use within the application:
Partial correction interval (tInt) to a predefined configurable value, for example 250 milliseconds (ms)
Targeted clock accuracy (pClock) to a predefined configurable variable, for example 5 parts per million (PPM)
Minimum time between corrections (tMin) to a predefined configurable variable, for example 10 seconds (s)
   For the purposes of this description, the method 300, the application 116 shown in FIG. 2 is executed by a non-routing device 110, though any device in the system 110 may store application software in its memory to perform such a method. Once the variables have been initialized from values stored in memory 114 or received from another device, the method proceeds to step 315.

In step 315, the non-routing device 110 activates its wireless communications device 112 to receive a message from a remote device. For example, in one embodiment, the wireless communications device 112 is activated to transmit a message to a clock source, such as a backbone router 130. The wireless communications device then remains activated to receive a message acknowledgement from the remote device. In another embodiment, the processor 111 activates the wireless communications device 112 based at least in part on the time base and an expected time of arrival for a timing message, such as a DAUX message, from a remote device.

In step 320, if the non-routing device 110 receives an ACK message from a clock source, the application 116 proceeds to step 350, otherwise it proceeds to step 330. In the embodiment shown in FIG. 3, ACK messages comprise more accurate timing information than a DAUX message, and so the non-routing device does not need to wait for a DAUX message to arrive before proceeding to step 350.

In step 330, if the non-routing device 110 receives a DAUX message, the application 116 proceeds to step 340, otherwise it returns to step 320.

In step 340, after receiving the DAUX message, the application 116 determines the elapsed time since the last received ACK message. If the elapsed time is less than the value of tMin, the application 116 returns to step 320. In this embodiment, this step may allow the more precise information from the ACK message to be used, if one has been received recently. Otherwise, the application 116 moves to step 350.

In step 350, the application 116 calculates the drift that has occurred over time based on its crystal oscillator, and stores the calculated drift value in memory 114. In one embodiment, the application 116 calculates the drift value by determining the difference in PPM between the timing information received in either the ACK or DAUX message and the time base maintained by the non-routing device 110. After calculating the drift value, the application 116 proceeds to step 360.

In step 360, the application 116 compares the drift value to the pClock value initialized in step 310 and stored in memory 114. If the drift value is greater than the pClock value, the application 116 proceeds to step 362. Otherwise, the application 116 proceeds to step 370.

In step 362, the application 116 adjusts its time base by the value of pClock. For example, in one embodiment, the application 116 maintains a count of the number of oscillation signals received from its crystal oscillator 115. To adjust the time base, the application 116 may add or subtract the pClock value from the maintained count.

In step 364, the application 116 adjusts the drift value by subtracting the maximum correction value from the previous drift value, thus reflecting the adjustment made to the maintained time base and the remaining drift to be corrected.

In step 366, the application 116 waits tInt milliseconds before returning to step 360 to further adjust its time base. Thus, in the embodiment shown in FIG. 3, the application 116 only adjusts its maintained time base by a maximum amount per iteration. In such an embodiment, spurious drift measurements may have less of an impact on clock synchronization because the synchronization occurs over longer period of time. This may allow updated or more accurate timing information to be received in a subsequent ACK or DAUX message before the entire correction is made. Such an incremental adjustment to the time base may also prevent the device from become unsynchronized from other devices in the network by changing too quickly. However, in some embodiments, the entire correction may be made in a single adjustment rather than with smaller adjustments over a period of time and so after executing step 350, the application 116 may proceed directly to step 370.

In step 370, the application 116 adjusts its time base by the drift value, and the method returns to step 320. In an embodiment in which the time base is gradually adjusted by at most the pClock value, in step 370, the adjustment will be at most the value of pClock.

The method shown in FIG. 3 results in the gradual adjustment of the time base maintained by a device over time, with a correction step value of pClock. As a result, possible erroneous corrections with large values may be filtered out. Also, the iterative correction over time may prevent the device from becoming de-synchronized from other devices, which could occur if the time base is suddenly changed by a large amount.

In the embodiment described above, timing information is received in two different message formats available in the ISA 100a networking protocol. However, the method is not limited to application in such networks and may be used with other networking configurations. For example, a device may receive timing information from a network over a cellular network or over a Wifi network. Further, timing information maybe received in more than two different types of messages, as a part of only one type of message, or as a part of a user-defined timing message. Such network features could be easily handled using embodiments of the present invention to regulate clock precision in distributed devices.

Referring now to FIG. 4, FIG. 4 shows a method for regulating clock precision in distributed devices according to one embodiment of the present invention. The method shown in FIG. 4 is described with respect to the system shown in FIGS. 1 and 2. The above algorithm can be modified to be used by non-routing devices and routing devices running on batteries by performing the steps as presented below.

The method 400 shown in FIG. 4 is similar to the method 300 described above with respect to FIG. 3, however, the method 400 shown in FIG. 4 provides for calculating an average drift. This may allow a device to pre-emptively correct its time base to compensate for expected drift, and thereby reduce the frequency at which DAUX messages are received. This may reduce power consumption and increase battery life. Like the description of the embodiment shown in FIG. 3, the method shown in FIG. 4 is configured to be loaded into memory and executed by a processor as a software application.

The method 400 begins in step 410. In the embodiment shown, the processor in a device, such as a non-routing device 110 or a routing device 120, executes application software that initializes several variables for use within the application:
Partial correction interval (tInt) to a predefined configurable value, for example 250 milliseconds (ms)
Targeted clock accuracy (pClock) to a predefined configurable variable, for example 5 parts per million (PPM)
Minimum time between corrections (tMin) to a predefined configurable variable, for example 10 seconds (s)
DAUX timeout tOut to a predefined configurable value
DAUX time increment dt to a predefined configurable value
The number of consecutive clock drift values ‘n’ to be averaged
minDrift and maxDrift to predefined configurable values
   Once the variables have been initialized, the application executed by the processor 111 proceeds to step 415.

In step 415, the non-routing device 110 activates its wireless communications device 112 to receive a message from a remote device. For example, in one embodiment, the wireless communications device 112 is activated to transmit a message to a clock source, such as a backbone router 130. The wireless communications device then remains activated to receive an ACK message from the remote device.

In step 420, if the non-routing device 110 receives an ACK message, the application 116 proceeds to step 450, otherwise the method proceeds to step 425.

In step 425, the application 116 determines whether tOut is less than or equal to 0. If so, the application 116 activates the wireless communications device 112 at an appropriate time to receive a DAUX message. However, if tOut is greater than 0, the application 116 returns to step 415.

In step 430, if a DAUX message has been received, the application 116 proceeds to step 440, otherwise it returns to step 415. In the embodiment shown in FIG. 4, a device will only attempt to receive a DAUX message by activating its wireless communications device 112 if the value of tOut is less than or equal to 0. Otherwise, it will remain inactive, for example, to preserve battery power.

In step 440, after receiving the DAUX message, the application 116 determines the elapsed time since the last received ACK message. If the elapsed time is less than the value of tMin, the method returns to step 320. In this embodiment, this step may allow the more precise information from the ACK message to be used, if one has been received recently. Otherwise, the application 116 moves to step 350.

In step 450, the application 116 calculates the drift that has occurred over time based on its crystal oscillator, and stores the calculated drift value in memory 114. The non-routing device 110 calculates the drift value by determining the difference in PPM between the timing information received in either the ACK or DAUX message and the time base maintained by the non-routing device 110. After calculating the drift value, the method proceeds to step 460.

In step 460, the application 116 calculates the average drift over the previous ‘n’ drift calculations. For example, in one embodiment, an average drift may be calculated by summing the drift values over the previous ‘n’ measurements and dividing the total by ‘n’. However, in some embodiments, a weighted average may be used. In such an embodiment, older drift values may be weighted less than more recent drift values. After calculating the drift average, the application 116 proceeds to step 470

In step 470, the application 116 calculates the absolute value of the difference between the current Drift value and the DriftAvg value. If the difference is less than the value of minDrift, the application 116 moves to step 472, otherwise it proceeds to step 474.

In step 472, the application 116 compares the absolute value of the difference to the value of maxDrift. If the absolute value of the difference is less than the value of maxDrift, the method proceeds to 476, otherwise the application 116 proceeds to step 474.

In step 474, the application 116 increases the DAUX timeout value, tOut, by the value of dt and stores the new tOut value in memory 114. The application 116 then proceeds to step 480.

In step 476, the application 116 increases the DAUX timeout value, tOut, by the value of dt and stores the new tOut value in memory 114. The application 116 then proceeds to step 480.

In step 478, the application 116 sets the DAUX timeout value, tOut, to 0 and stores the new value in memory 114. The application 116 then proceeds to step 480.

In step 480, the application 116 compares the drift value to the pClock value initialized in step 410 and stored in memory 114. If the drift value is greater than the pClock value, the application 116 proceeds to step 482. Otherwise, the application 116 proceeds to step 490.

In step 482, the application 116 adjusts its time base by the value of pClock. For example, in one embodiment, the application 116 maintains a count of the number of oscillation signals received from its crystal oscillator 115. To adjust the time base, the application 116 may add or subtract the pClock value from the maintained count.

In step 484, the application 116 adjusts the drift value by subtracting the maximum correction value from the previous drift value, thus reflecting the adjustment made to the maintained time base and the remaining drift to be corrected.

In step 486, the application 116 waits tInt milliseconds before returning to step 360 to further adjust its time base. Thus, in the embodiment shown in FIG. 4, the application 116 only adjusts its maintained time base by a maximum amount per iteration. In such an embodiment, spurious drift measurements may have less of an impact on clock synchronization because the synchronization occurs over longer period of time. This may allow updated or more accurate timing information to be received in a subsequent ACK or DAUX message before the entire correction is made. Such an incremental adjustment to the time base may also prevent the device from become unsynchronized from other devices in the network by changing too quickly. However, in some embodiments, the entire correction may be made in a single adjustment rather than with smaller adjustments over a period of time and so after executing step 480, the application 116 may proceed directly to step 490.

In step 490, the application 116 adjusts its time base by the drift value, and the application 116 returns to step 420. In an embodiment in which the time base is gradually adjusted by at most the pClock value, in step 490, the adjustment will be at most the value of pClock.

In the embodiment shown in FIG. 4, a device will enter receive mode for DAUX messages only when DAUX timeout tOut=0. As such, the embodiment shown in FIG. 4 may reduce the time needed for a routing device or non-routing device to be in receive mode, which may reduce power consumption. As long as the clock drift stays under the pre-configured value minDrift, the reading of the DAUX message is postponed by adding dt to tOut. This may extend the battery life of battery-powered routing devices 120 and non-routing devices 110 and may increase the economic viability of battery powered devices on wireless networks.

In a related embodiment, the method 400 comprises a further step of adjusting the time base with the value of DriftAvg. In such an embodiment, if the drift of the time base of a routing device or non-routing device's clock is constant, the compensation can be applied automatically without receiving DAUX messages for extended periods of time, which may effectively increase the time between clock synchronizations and reduce power consumption.

Systems and methods for regulating clock precision in distributed devices according to embodiments of the present invention may be repeated over time to ensure clocks are synchronized between one or more distributed devices.

Some portions of the detailed description were presented in terms of algorithms or symbolic representations of operations on data bits or binary signals stored within a computer in system memory, such as a computer memory. These algorithmic descriptions or representations are examples of techniques used by those of ordinary skill in the data processing arts to convey the substance of their work to others skill in the art. An algorithm is here and generally is considered to be a self-consistent sequence of operations or similar processing leading to a desired result. In this context, operations or processing involve physical manipulation of physical quantities, such as crystal oscillations or manipulation of radio transceivers and associated circuitry.

Typically, although not necessarily, such quantities may take the form of electrical or magnetic signals capable of being stored, transferred, combined, compared or otherwise manipulated. It has proven convenience at times, principally for reasons of common usage to refer to such signals as bits, data, values, elements, symbols, characters, terms numbers, numerals or the like. It should be understood, however, that all of these and similar terms are to be associated with appropriate physical quantities and are merely convenience labels.

Unless specifically stated otherwise, as apparent from the foregoing discussion, it is appreciated that throughout this specification discussions using terms such as “processing,” “computing,” “calculating,” “determining” or the like refer to actions or processes of a computing platform such as one or more computers and/or a similar electronic computing device or devices, that manipulate or transform data represented as physical electronic or magnetic quantities within memories, registers, or other information storage devices, transmission devices, or displayed devices of the computing platform.

The various systems discussed herein are not limited to any particular hardware architecture or configuration. A computing device can include any suitable arrangement of components that provide a result conditioned on one or more inputs. Suitable computing devices include multipurpose microprocessor-based computer systems accessing stored software that programs or configures the computing system from a general-purpose computing apparatus to a specialized computing apparatus implementing one or more embodiments of the present subject matter. Any suitable programming, scripting, or other type of language or combinations of languages may be used to implement the teachings contained herein in software to be used in programming or configuring a computing device.

Embodiments of the methods disclosed herein may be performed in the operation of such computing devices. The order of the blocks presented in the examples above can be varied—for example, blocks can be re-ordered, combined, and/or broken into sub-blocks. Certain blocks or processes can be performed in parallel.

As noted above, a computing device may access one or more computer-readable media that tangibly embody computer-readable instructions which, when executed by at least one computer, case the at least one computer to implement one or more embodiments of the present subject matter. When software is used, the software may comprise one or more components, processes and/or applications. Additionally or alternatively to software, the computing device(s) may comprise circuitry that renders the device(s) operative to implement one or more of the methods of the present subject matter.

The technology referenced herein also makes reference to communicating data between components or systems. It should be appreciated that such communications may occur over any suitable number or type of networks or links, including, but not limited to, a dial-in network, a local area network (LAN), a wide area network (WAN), public switched telephone network (PSTN), the Internet, an intranet or combination of hard-wired and/or wireless communication links.

Any tangible computer-readable medium or media may be used to implement or practice the subject matter disclosed herein, including, but not limited to, diskettes, drives, magnetic-based storage media, optical storage media, including disks (including CD-ROMs, DVD-ROMs, and variants thereof), flash, RAM, ROM, and other memory devices.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Headings, lists, and numbering included herein are for ease of explanation only and are not meant to be limiting.

### GENERAL

While the present subject matter has been described in detail with respect to specific embodiments thereof, it will be appreciated that those skilled in the art, upon attaining an understanding of the foregoing may readily produce alterations to, variations of, and equivalents to such embodiments. Accordingly, it should be understood that the present disclosure has been presented for purposes of example rather than limitation, and does not preclude inclusion of such modifications, variations and/or additions to the present subject matter as would be readily apparent to one of ordinary skill in the art.

That which is claimed:

1. A method comprising:
receiving a clock signal from an oscillator;
maintaining a signal count based on the clock signal;
receiving a message comprising timing information from a remote device;
calculating a drift value based at least in part on the timing information;
determining whether the drift is greater than a targeted clock accuracy;
while the drift value is greater than the targeted clock accuracy:
adjusting the signal count by the targeted clock accuracy,
educing the drift value by the targeted clock accuracy, and
waiting a partial correction interval;
if the drift value is less than the targeted clock accuracy:
adjusting the signal count by the drift value;
determining a receive time for a network message based at least in time on the signal count; and
activating a wireless receiver based on the receive time to receive a message.

2. The method of claim 1, wherein the message comprises one of an ACK message or a DAUX message.

3. The method of claim 1, further comprising receiving a plurality of messages.

4. The method of claim 3, wherein the plurality of messages comprises at least one ACK message and at least one DAUX message.

5. The method of claim 4, wherein calculating the drift value is based at least in part on the ACK message.

6. The method of claim 4, wherein the DAUX message is received more than an interval between corrections after the ACK message, and the step of calculating the drift value is performed again based at least in part on the DAUX message.

7. The method of claim 4, wherein the DAUX message is received less than an interval between corrections after the ACK message, and calculating the drift value is not performed again based at least in part on the DAUX message at least until the interval between corrections has elapsed.

8. The method of claim 1, further comprising:
computing a drift average value based at least in part on the drift value;
if the difference between the drift value and the drift average value is less than a minimum drift value, increasing a timeout counter by a DAUX time increment value;
if the difference between the drift value and drift average value is less than a maximum drift value, but greater than the minimum drift value, decreasing the timeout counter by the DAUX time increment value; and
otherwise, setting the timeout counter to 0.

9. The method of claim 8, further comprising activating the wireless receiver to receive a DAUX message if the timeout counter is less than or equal to 0.

10. A computer-readable medium comprising program code, the program code comprising:
program code for receiving a clock signal from an oscillator;
program code for maintaining a signal count based on the clock signal;
program code for receiving a message comprising timing information from a remote device;
program code for calculating a drift value based at least in part on the timing information;
program code for determining whether the drift is greater than a targeted clock accuracy;
while the drift value is greater than the targeted clock accuracy:
program code for adjusting the signal count by the targeted clock accuracy,
program code for reducing the drift value by the targeted clock accuracy, and
program code for waiting a partial correction interval;
if the drift value is less than the targeted clock accuracy:
program code for adjusting the signal count by the drift value;
program code for determining a receive time for a network message based at least in time on the signal count; and
program code for activating a wireless receiver based on the receive time to receive a message.

11. The computer-readable medium of claim 10, wherein the message comprises one of an ACK message or a DAUX message.

12. The computer-readable medium of claim 10, further comprising program code for receiving a plurality of messages.

13. The computer-readable medium of claim 12, wherein the plurality of messages comprises at least one ACK message and at least one DAUX message.

14. The computer-readable medium of claim 13, wherein calculating the drift value is based at least in part on the ACK message.

15. The computer-readable medium of claim 13, wherein the DAUX message is received more than an interval between corrections after the ACK message, and the program code for calculating the drift value is configured to be executed again based at least in part on the DAUX message.

16. The computer-readable medium of claim 13, wherein the DAUX message is received less than an interval between corrections after the ACK message, and the program code for calculating the drift value is configured to not be performed again based at least in part on the DAUX message at least until the interval between corrections has elapsed.

17. The computer-readable medium of claim 10, further comprising:
program code for computing a drift average value based at least in part on the drift value;
program code for increasing a timeout counter by a DAUX time increment value, the program code for increasing a timeout counter configured to be executed if the difference between the drift value and the drift average value is less than a minimum drift value;
program code for decreasing the timeout counter by the DAUX time increment value, the program code for decreasing the timeout counter configured to be executed if the difference between the drift value and drift average value is less than a maximum drift value, but greater than the minimum drift value; and
program code for setting the timeout counter to 0, the program code for setting the timeout counter to 0 if the difference between the drift value and the drift average value is greater than the maximum drift value.

18. The computer-readable medium of claim 17, further comprising program code for activating the wireless receiver to receive a DAUX message, the program code for activating the wireless received configured to be executed if the timeout counter is less than or equal to 0.

19. A system, comprising:
a crystal oscillator;
a wireless receiver; and
a processor in communication with the crystal oscillator and the wireless transceiver; the processor configured to:
receive a clock signal from the crystal oscillator;
maintain a signal count based on the clock signal;
receive a message from a remote device, the message comprising timing information;
calculate a drift value based at least in part on the timing information;
determine whether the drift is greater than a targeted clock accuracy;
while the drift value is greater than the targeted clock accuracy:
adjust the signal count by the targeted clock accuracy,
reduce the drift value by the targeted clock accuracy, and
wait a partial correction interval;
if the drift value is less than the targeted clock accuracy:
adjust the signal count by the drift value;
determine a receive time for a network message based at least in time on the signal count; and
activate the wireless receiver based on the receive time to receive a message.

20. The system of claim 19, wherein the processor is further configured to:
compute a drift average value based at least in part on the drift value;
increase a timeout counter by a DAUX time increment value if the difference between the drift value and the drift average value is less than a minimum drift value;
decrease the timeout counter by the DAUX time increment value if the difference between the drift value and drift average value is less than a maximum drift value, but greater than the minimum drift value; and
set the timeout counter to 0 if the difference between the drift value and the drift average value is greater than the maximum drift value.

21. The system of claim 20, wherein the processor is further configured to activate the wireless receiver to receive a DAUX message if the timeout counter is less than or equal to 0.
